(19) United States
(12) Patent Application Publication
(10) Pub. No.: US 2019/0070829 A1
(43) Pub. Date: Mar. 7, 2019

(54) REINFORCED FIBER LAMINATE SHEET, FIBER-REINFORCED RESIN MOLDED BODY, AND METHOD OF MANUFACTURING REINFORCED FIBER LAMINATE SHEET

(71) Applicant: Toray Industries, Inc., Tokyo (JP)

(72) Inventors: Shingo Miura, Nagoya (JP); Masayuki Sato, Nagoya (JP); Toyokazu Hino, Nagoya (JP)

(21) Appl. No.: 16/081,113

(22) PCT Filed: Mar. 29, 2017
(86) PCT No.: PCT/JP2017/012881

§ 371 Date: Aug. 30, 2018

(30) Foreign Application Priority Data
Mar. 31, 2016 (JP) 2016-070827
Mar. 31, 2016 (JP) 2016-070828

(51) Int. Cl. B32B 5/26; C08J 5/04; B32B 27/12

(52) U.S. Cl. CPC B32B 5/26; C08J 5/04; B32B 27/12; B32B 2309/02; B32B 2305/08; B32B 2307/3065; B32B 2309/12

(57) ABSTRACT

A reinforced fiber sheet exhibits a stable shape and favorable bulking properties, a method of manufacturing same, and a fiber-reinforced resin molded body. The reinforced fiber sheet includes a plurality of reinforced fiber bundles arranged in one direction, wherein first and second reinforced fiber bundle layers, in which there is no direct binding force between reinforced fiber bundles within a layer, are disposed to have mutually distinct fiber orientations, and are integrally formed by being fastened together using fastening elements, satisfying conditions (i) and (ii): (i) fastening surfaces of the first and second reinforced fiber bundle layers have fastening sections that include at least one fastening element, and an average surface area S1 of 100 mm²; (ii) in the fastening sections, the surface area ratio of the fastening elements to the fastening section is 0.1% to 80%.

### TECHNICAL FIELD

This disclosure relates to a reinforced fiber laminate sheet, a fiber-reinforced resin molded body made from the reinforced fiber laminate sheet and a matrix resin, and a method of manufacturing a reinforced fiber laminate sheet.

### BACKGROUND

Fiber reinforced plastics (FRPs), in particular, carbon fiber reinforced plastics (CFRPs) made from carbon fibers are light and excellent in mechanical properties such as strength and rigidity. Therefore, in recent years, FRPs are increasingly applied to transportation equipment in aerospace, automobiles and the like, sports applications, industrial applications and the like based on their properties.

As representative methods of manufacturing FRPs, autoclave molding, resin transfer molding (RTM), and vacuum assisted resin transfer molding (VaRTM) are known. Until now, autoclave molding using a prepreg has been employed to obtain aircraft members that are particularly required to have high reliability and quality. In this method, for example, prepregs made of a group of reinforced fiber bundles arranged in one direction and preimpregnated with a matrix resin are laminated in a molding die, covered with a bag material as needed, and heated and pressurized in an autoclave to give a molded body made from an FRP.

In recent years, in the step of laminating prepregs, an automatic tape layup (ATL) machine that laminates narrowly slit prepregs is used. Use of the ATL machine is aimed at automation of the lamination step and improvement in the material yield particularly for members not so uneven and having a wide surface shape. However, it is difficult to apply that machine to an uneven member or a member having a three-dimensionally complicated shape. For this reason, attempts have been made to deform the laminate of prepregs with a draping die adapted to a desired shape. However, prepregs do not have sufficient deformability to fine unevenness or a complicated three-dimensional shape since the impregnated matrix resin binds the reinforced fibers together. This leads to wrinkle generation and adversely affects mechanical properties.

Furthermore, to obtain aircraft members by molding using prepregs, expensive autoclave equipment is generally used. In particular, a huge autoclave is used to obtain large-sized members such as main wings and tail wings by molding, and it is difficult to reduce the manufacturing cost.

Therefore, use of the RTM and VaRTM that do not require a large-sized autoclave and can shorten the cycle time has been studied. In those molding methods, a molded body made from an FRP is obtained by placing, in a molding die, a laminate of substrates such as a dry fabric not impregnated with a matrix resin, or a molding precursor called a preform obtained by further draping the laminate into a desired shape, clamping the molding die, and then injecting a low-viscosity liquid matrix resin into the molding die to impregnate the reinforced fiber with the matrix resin. The substrates used in those molding methods such as a dry fabric, are a textile substrate obtained by weaving reinforced fiber bundles into a plain weave or a twill weave, and a non-crimpled substrate obtained by engaging reinforced fiber bundles aligned in parallel by a method such as stitching with an auxiliary yarn for form retention. Both of the substrates are reinforced fiber substrates having a form in which preliminarily produced reinforced fiber bundles adjacent to each other in the surface of a fabric are preliminarily bound together to be integrated, and the reinforced fiber bundles are continuous in the longitudinal direction at a constant width and a constant basis weight. Therefore, in those substrates, the reinforced fibers are not strongly bound together by the matrix resin. Therefore, those substrates have characteristics that they can be deformed into a desired shape even if it is a complicated three-dimensional shape such as a curved shape or an uneven shape more easily than prepregs do, and can suppress wrinkles that adversely affect mechanical properties if the substrates are appropriately draped.

Furthermore, in recent years, also in the RTM and VaRTM, automated fiber placement (AFP) of sequentially arranging required lengths of reinforced fibers only at positions where the reinforced fibers are required to give a reinforced fiber substrate has been attracting attention as a technique high in productivity and capable of greatly reducing the amount of waste of reinforced fibers.

In the AFP, dry reinforced fiber bundles are formed into a sheet form, for example, by aligning the dry reinforced fiber bundles in one direction in a planar shape to form one reinforced fiber bundle layer, and binding adjacent reinforced fiber bundles together, or laminating a plurality of reinforced fiber bundle layers and binding the layers together. Attempts have been made to bind the reinforced fiber bundles (reinforced fiber bundle layers) into a sheet form by binding by attachment with a resin, binding by suture with a suture thread and the like.

For example, Japanese Patent Laid-open Publication No. 2014-159099 discloses a technique of forming reinforced fiber bundles into a sheet form by arranging a plurality of reinforced fiber bundles in one direction on a predetermined position of a sheet-shaped base substrate and randomly attaching the reinforced fiber bundles onto the base substrate. That technique made it possible to integrate the reinforced fiber bundles into a reinforced fiber sheet based on the attachment of the reinforced fiber bundles to the base substrate.

Meanwhile, apart from the AFP, as disclosed in Japanese Patent Laid-open Publication No. 2009-235182, there is known a reinforced fiber substrate including a fixing material made from a thermoplastic resin material placed between a unidirectional reinforced fiber layer and another unidirectional reinforced fiber layer having a different fiber orientation from the fiber orientation of the above-mentioned reinforced fiber layer to thermally fuse the reinforced fiber layers together.

Further, as means of binding reinforced fiber layers together, for example, as disclosed in Japanese Patent Laid-open Publication No. 2007-276453, there is known a technique of partially fixing reinforced fiber layers each having a fixing material together to improve deformability of the reinforced fiber laminate.

The techniques disclosed in Japanese Patent Laid-open Publication No. 2009-235182 and Japanese Patent Laid-open Publication No. 2007-276453 are effective for a laminate of textile substrates in which adjacent reinforced fiber bundles are bound together by a filling yarn, an auxiliary yarn or the like.

However, in the reinforced fiber sheet produced by the method disclosed in Japanese Patent Laid-open Publication No. 2014-159099, although the base substrate has slits, the reinforced fiber sheet is relatively low in drapability and incapable of being adequately draped without generation of wrinkles or rucking of the reinforced fibers as for a complicated three-dimensional shape having a large curved surface. That method also has a problem that an unnecessary base substrate must be used depending on the molded article.

The techniques disclosed in Japanese Patent Laid-open Publication No. 2009-235182 and Japanese Patent Laid-open Publication No. 2007-276453 cannot be employed in integrating reinforced fiber bundles that are arranged by the AFP and are not directly bound together to form the reinforced fiber bundles into a sheet. In those techniques, sheets in which adjacent fibers are bound together by the weave structure are merely partially fixed together, and those techniques do not provide a means of fixing “aligned adjacent reinforced fibers that are different in length from each other” together, which is specific to sheets obtained by the AFP. In other words, those disclosures do not disclose a means of binding unbound reinforced fiber bundles together with adequate fixing force to drape the reinforced fiber bundles without disturbing the fiber orientation and without generation of wrinkles or nicking of the reinforced fibers, which is specific to binding reinforced fiber bundle layers obtained by the AFP together. Therefore, a reinforced fiber laminate sheet having sufficient drapability cannot be obtained even with reference to those disclosures.

As described above, it was previously impossible to realize a reinforced fiber laminate sheet having sufficient drapability, which is obtained by binding unbound reinforced fiber bundles together with adequate fixing force without the use of any other substrate such as a base substrate, and is drapable without disturbance of the fiber orientation and without generation of wrinkles or nicking of the reinforced fibers.

Furthermore, if merely the binding force between the reinforced fiber bundles is weakened to improve the drapability, the reinforced fiber bundles are easily displaced or delaminated from each other so that the form of a reinforced fiber laminate sheet cannot be maintained. As a result, it is impossible to use the reinforced fiber bundles as a reinforced fiber sheet because the reinforced fiber sheet cannot be conveyed to subsequent steps, or the reinforced fiber sheet is wrinkled or nicked or the reinforced fiber bundles are delaminated from each other after the sheet is draped. Even if such a reinforced fiber sheet is molded by the RTM, wrinkles and the like remain in the reinforced fiber layer in the resulting molded body, and it is absolutely impossible to obtain desired mechanical properties.

It could therefore be helpful to provide a reinforced fiber laminate sheet capable of being handled as a sheet owing to integration of adjacent reinforced fiber bundles that are not directly bound together, and also capable of deforming following the shape of a die in draping while retaining the sheet form, and a method of manufacturing the reinforced fiber laminate sheet. It could also be helpful to provide, using the reinforced fiber laminate sheet, a fiber-reinforced resin molded body that has no defects such as wrinkles generated during the draping and is excellent in molded body properties.

### SUMMARY

We found that it is possible to obtain a reinforced fiber laminate sheet excellent in both drapability and form stability of the sheet by fixing, in a specific form, a fixing element present between unidirectional reinforced fiber bundle layers that are arranged to have different fiber orientations from each other. The “fixing element” means a fixing material involved in fixation among fixing materials present between the reinforced fiber bundle layers.

We therefore provide:

(1) A reinforced fiber laminate sheet including: a first reinforced fiber bundle layer and a second reinforced fiber bundle layer that are each formed of a plurality of reinforced fiber bundles aligned in one direction, that are arranged to have different fiber orientations from each other, and in which reinforced fiber bundles in one layer have no direct binding force between each other, the first reinforced fiber bundle layer and the second reinforced fiber bundle layer being fixed to each other by a fixing element so that the first reinforced fiber bundle layer and the second reinforced fiber bundle layer are integrated with each other, the reinforced fiber laminate sheet satisfying the following conditions (i) and (ii):

(i) the reinforced fiber laminate sheet has one or more fixing portions each including at least one fixing element at a fixing surface between the first reinforced fiber bundle layer and the second reinforced fiber bundle layer, and the fixing portions have an average area S₁ of 100 mm² or less; and

(ii) in each of the fixing portions, an area rate of the fixing element to the fixing portion is 0.1% or more and 80% or less.

(2) A reinforced fiber laminate sheet including: a first reinforced fiber bundle layer and a second reinforced fiber bundle layer that are each formed of a plurality of reinforced fiber bundles aligned in one direction, that are arranged to have different fiber orientations from each other, and in which reinforced fiber bundles in one layer have no direct binding force between each other, the first reinforced fiber bundle layer and the second reinforced fiber bundle layer being fixed to each other by a fixing element so that the first reinforced fiber bundle layer and the second reinforced fiber bundle layer are integrated with each other, the reinforced fiber laminate sheet satisfying the following conditions (i) and (iii):

(i) the reinforced fiber laminate sheet has one or more fixing portions each including at least one fixing element at a fixing surface between the first reinforced fiber bundle layer and the second reinforced fiber bundle layer, and the fixing portions have an average area S₁ of 100 mm² or less; and

(iii) the fixing element is a particulate or fiber assembly-shaped fixing material that is melted.

(3) The reinforced fiber laminate sheet according to the item (1) or (2), having a fixing region including at least one of the fixing portions at the fixing surface between the first reinforced fiber bundle layer and the second reinforced fiber bundle layer, wherein an area rate of the fixing region to the reinforced fiber laminate sheet is 30% or more and 100% or less.

(4) The reinforced fiber laminate sheet according to any one of the items (1) to (3), having at least one fixing region in which an area rate of one or more fixing portions to the fixing region is 1% or more and 50% or less.

(5) The reinforced fiber laminate sheet according to any one of the items (1) to (4), further satisfying the following condition (iv):

(iv) the reinforced fiber laminate sheet has a fixing region in which centers of the fixing portions are arranged in a polygonal grid.

(6) The reinforced fiber laminate sheet according to any one of the items (1) to (5), further satisfying the following condition (v):

(v) centers of the fixing portions are arranged in a regular polygonal grid having a side length L₁ (mm), and the length L₁ (mm) satisfies the following expression (1):

1≤L₁≤50 (1).

(7) A fiber-reinforced resin molded body including: the reinforced fiber laminate sheet according to any one of the items (1) to (6); and a matrix resin.

(8) A method of manufacturing a reinforced fiber laminate sheet, the method including the following steps (a) to (c):

(a) a first reinforced fiber bundle layer arrangement step of arranging a plurality of reinforced fiber bundles aligned in one direction on a table to give a first reinforced fiber bundle layer in which reinforced fiber bundles in one layer have no direct binding force between each other;

(b) a second reinforced fiber bundle layer arrangement step of further arranging, on the first reinforced fiber bundle layer, a plurality of reinforced fiber bundles aligned in one direction that is different from a fiber direction of the first reinforced fiber bundle layer to give a second reinforced fiber bundle layer in which reinforced fiber bundles in one layer have no direct binding force between each other, and thus producing a reinforced fiber laminate; and

(c) a sheet forming step of obtaining a reinforced fiber laminate sheet satisfying the following conditions (i) and (ii) using a sheet forming mechanism of partially heating and/or pressurizing the reinforced fiber laminate via a protrusion on a surface in contact with the reinforced fiber laminate to melt a fixing material between the first reinforced fiber bundle layer and the second reinforced fiber bundle layer:

(i) the reinforced fiber laminate sheet has one or more fixing portions each including at least one fixing element at a fixing surface between the first reinforced fiber bundle layer and the second reinforced fiber bundle layer, and the fixing portions have an average area S₁ of 100 mm² or less; and

(ii) in each of the fixing portions, an area rate of the fixing element to the fixing portion is 0.1% or more and 80% or less.

(9) A method of manufacturing a reinforced fiber laminate sheet, the method including the following steps (a) to (c):

(a) a first reinforced fiber bundle layer arrangement step of arranging a plurality of reinforced fiber bundles aligned in one direction on a table to give a first reinforced fiber bundle layer in which reinforced fiber bundles in one layer have no direct binding force between each other;

(b) a second reinforced fiber bundle layer arrangement step of further arranging, on the first reinforced fiber bundle layer, a plurality of reinforced fiber bundles aligned in one direction that is different from a fiber direction of the first reinforced fiber bundle layer to give a second reinforced fiber bundle layer in which reinforced fiber bundles in one layer have no direct binding force between each other, and thus producing a reinforced fiber laminate; and

(c) a sheet forming step of obtaining a reinforced fiber laminate sheet satisfying the following conditions (i) and (iii) using a sheet forming mechanism of partially heating and/or pressurizing the reinforced fiber laminate via a protrusion on a surface in contact with the reinforced fiber laminate to melt a fixing material between the first reinforced fiber bundle layer and the second reinforced fiber bundle layer:

(i) the reinforced fiber laminate sheet has one or more fixing portions each including at least one fixing element at a fixing surface between the first reinforced fiber bundle layer and the second reinforced fiber bundle layer, and the fixing portions have an average area S₁ of 100 mm² or less; and

(iii) the fixing element is a particulate or fiber assembly-shaped fixing material that is melted.

(10) The method of manufacturing a reinforced fiber laminate sheet according to the item (8) or (9), including the following step (a1) between steps (a) and (b):

(a1) a fixing material placement step of placing a fixing material on the first reinforced fiber bundle layer.

(11) The method of manufacturing a reinforced fiber laminate sheet according to any one of the items (8) to (10), wherein the reinforced fiber bundles in step (a) and/or step (b) are reinforced fiber bundles to which a fixing material is attached.

(12) The method of manufacturing a reinforced fiber laminate sheet according to any one of the items (8) to (11), wherein the reinforced fiber laminate sheet has a fixing region including at least one of the fixing portions at the fixing surface between the first reinforced fiber bundle layer and the second reinforced fiber bundle layer, and an area rate of the fixing region to the reinforced fiber laminate sheet is 30% or more and 100% or less.

(13) The method of manufacturing a reinforced fiber laminate sheet according to the item (12), wherein the reinforced fiber laminate sheet has at least one fixing region in which an area rate of one or more fixing portions to the fixing region is 1% or more and 50% or less.

(14) The method of manufacturing a reinforced fiber laminate sheet according to any one of the items (8) to (12), further satisfying the following condition (iv):

(iv) the reinforced fiber laminate sheet has a fixing region in which centers of the fixing portions are arranged in a polygonal grid.

(15) The method of manufacturing a reinforced fiber laminate sheet according to any one of the items (8) to (14), further satisfying the following condition (v):

(v) centers of the fixing portions are arranged in a regular polygonal grid having a side length L₁ (mm), and the length L₁ (mm) satisfies the following expression (1):

1≤L₁≤50 (1).

(16) The method of manufacturing a reinforced fiber laminate sheet according to any one of the items (8) to (15), including the following step (d) simultaneously with or after step (c):

(d) a fixing frame forming step of forming a fixing frame in at least a part of an end of the reinforced fiber laminate sheet.

(17) The method of manufacturing a reinforced fiber laminate sheet according to any one of the items (8) to (16), wherein the table has means of adsorbing and holding the reinforced fiber bundles, and the means has a mechanism based on electrostatic attraction and/or a mechanism based on attractive force generated by flow of air.

The reinforced fiber laminate sheet exhibits high drapability while exhibiting the same degree of form stability as that of a conventional textile substrate.

In addition, according to the method of manufacturing a reinforced fiber laminate sheet, it is possible to obtain the reinforced fiber laminate sheet.

Further, the fiber-reinforced resin molded body has no defects or the like caused by wrinkles made during the draping, and is excellent in molded body properties.

### BRIEF DESCRIPTION OF THE DRAWINGS

FIG. 1 is a schematic view showing an example of a reinforced fiber laminate sheet.

FIGS. 2a to 2g are schematic views each showing an example of a grid of fixing portions.

FIG. 3 is a schematic view showing an example of the reinforced fiber laminate sheet.

FIG. 4 is a flowchart showing one example of a method of manufacturing a reinforced fiber laminate sheet.

FIG. 5 is a schematic view illustrating a relationship among fixing elements, fixing portions, and fixing regions.

FIG. 6 is a flowchart showing another example of the method of manufacturing a reinforced fiber laminate sheet.

FIG. 7 is a schematic perspective view of a simple element shape die used in evaluating the drapability of the reinforced fiber laminate sheet.

FIG. 8 is a perspective view of a model shape die 1 used in evaluating the drapability of the reinforced fiber laminate sheet as well as molded body properties of a fiber-reinforced resin molded body.

FIG. 9 is a perspective view of a model shape die 2 used in evaluating the drapability of the reinforced fiber laminate sheet as well as molded body properties of the fiber-reinforced resin molded body.

### DESCRIPTION OF REFERENCE SIGNS

101, 301: Reinforced fiber laminate sheet
102, 103, 302, 303: Reinforced fiber bundle layer
104, 204, 304, 502: Fixing portion
105, 305, 501: Fixing element
106, 306, 503: Fixing region
107, 504: Fixing material
307: Frame-shaped fixing region
208: Grid
401, 601: First reinforced fiber bundle layer arrangement step
402, 603: Second reinforced fiber bundle layer arrangement step
403, 604: Sheet forming step
505: First reinforced fiber bundle layer
602: Fixing material placement step

### DETAILED DESCRIPTION

A reinforced fiber laminate sheet is a reinforced fiber laminate sheet including: a first reinforced fiber bundle layer and a second reinforced fiber bundle layer each formed of a plurality of reinforced fiber bundles aligned in one direction, arranged to have different fiber orientations from each other, and in which reinforced fiber bundles in one layer have no direct binding force between each other, the first reinforced fiber bundle layer and the second reinforced fiber bundle layer being fixed to each other by a fixing element so that the first reinforced fiber bundle layer and the second reinforced fiber bundle layer are integrated with each other, the reinforced fiber laminate sheet satisfying the following conditions (i) and (ii) or (i) and (iii):

(i) the reinforced fiber laminate sheet has one or more fixing portions each including at least one fixing element at a fixing surface between the first reinforced fiber bundle layer and the second reinforced fiber bundle layer, and the fixing portions have an average area S₁ of 100 mm² or less;

(ii) in each of the fixing portions, an area rate of the fixing element to the fixing portion is 0.1% or more and 80% or less; and

(iii) the fixing element is a particulate or fiber assembly-shaped fixing material that is melted.

The “fixing material” means a resin attached to the reinforced fiber bundles and softened by heating. The “fixing element” means a fixing material involved in fixation among fixing materials present between the first and second reinforced fiber bundle layers. Among the fixing materials, fixing elements involved in fixation and fixing materials not involved in fixation are distinguished by the following method. First, a reinforced fiber bundle layer not having a fixing material is observed with a digital microscope (VHX-1000 manufactured by Keyence Corporation) and used as a control. Then, two reinforced fiber bundle layers that constitute a reinforced fiber laminate sheet are delaminated from each other, and fixing materials attached to the reinforced fiber bundle layers are observed with a digital microscope (VHX-1000 manufactured by Keyence Corporation). The images of the fixing materials obtained by the above-mentioned method are classified into when traces of the fixing materials attached to the reinforced fiber bundle layers having different orientations from each other are recognized and when such traces are not recognized, and the fixing materials in the former case are judged as fixing elements. As for the criterion for the judgment, when the state in which the fixing materials are applied to the fixing surface is preserved is regarded as when traces of the fixing materials attached to the reinforced fiber bundle layers are not recognized. On the other hand, when streaky traces in the orientation direction of the reinforced fiber bundles remain on the fixing materials is regarded as when traces of the fixing materials attached to the reinforced fiber bundle layers having different orientations from each other are recognized.

The “fixing portion” means a portion determined by the following procedure.

1) If the distance between a fixing element and another fixing element is 1 mm or less, these fixing elements are assumed to be continuous with each other.

2) A set of fixing elements that are directly or indirectly continuous with each other is regarded as a fixing element group. As for fixing elements that are not continuous with any other fixing element, one fixing element is regarded as one fixing element group.

3) A part surrounded by a smallest circle including all the fixing elements belonging to one fixing element group is regarded as a fixing portion. Further, areas of circles defined as fixing portions are calculated, and the average area of all the fixing portions included in the reinforced fiber sheet is defined as S₁.

The “fixing region” means a region determined by the following procedure.

1) If the distance between a fixing portion and another fixing portion is 100 mm or less, these fixing portions are assumed to be continuous with each other.

2) A set of fixing portions directly or indirectly continuous with each other is regarded as a fixing portion group. A set of fixing portions composed of two or less fixing portions, or a set of fixing portions composed of two or more fixing portions and in which all the fixing portions line up in a straight line is not a fixing portion group.

3) A polygon obtained by connecting the centers of fixing portions belonging to one fixing portion group with a straight line, and having a largest area among polygons each including all the fixing portions belonging to the fixing portion group in the inside or on the periphery thereof is regarded as a fixing region. Further, the average area of all the fixing regions included in the reinforced fiber laminate sheet is defined as S₂.

The “drapability” means a property that the reinforced fiber laminate sheet is easy to follow a three-dimensional mold without generation of wrinkles of the sheet or rucking of the fibers. The “form stability” means a property that the reinforced fiber bundles are not delaminated from each other and remain being bound together even in draping, and are capable of retaining the integrity as a sheet. The drapability and form stability are both evaluated by the methods described later.

Hereinafter, desirable examples will be described with reference to the drawings. It should be noted that this disclosure is not limited to the examples shown in the drawings.

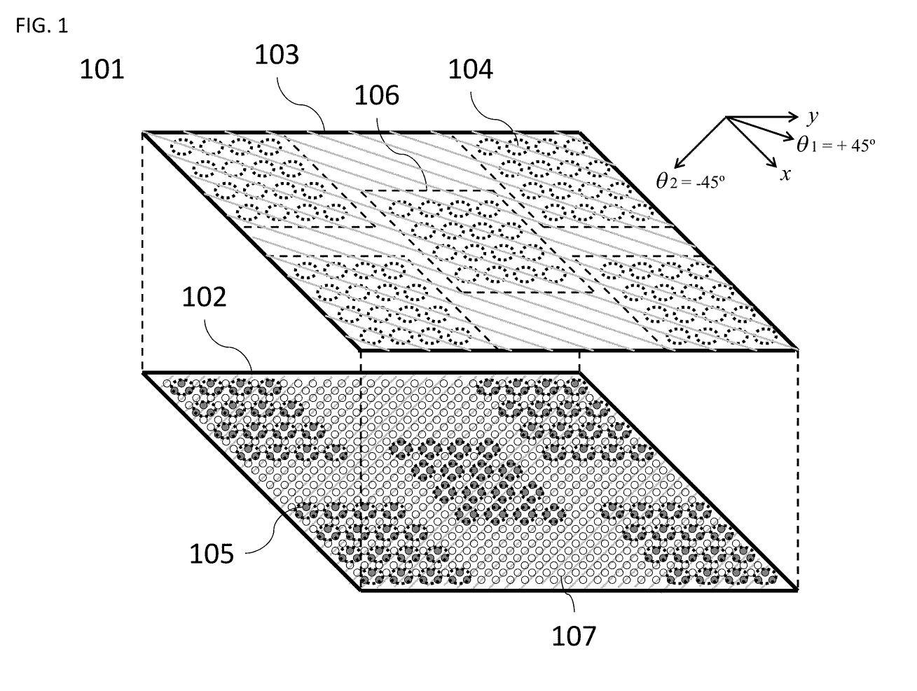

FIG. 1 is a schematic view showing an example of a reinforced fiber laminate sheet. A reinforced fiber laminate sheet 101 in FIG. 1 is a reinforced fiber laminate sheet including reinforced fiber bundle layers 102 and 103 each formed of a plurality of reinforced fiber bundles aligned in one direction, arranged to have different fiber orientations from each other, and in which reinforced fiber bundles in one layer have no direct binding force between each other. FIG. 1 shows an example in which layers of reinforced fiber bundles are laminated such that the fiber orientation of the reinforced fiber bundles is ±45° (fiber orientation θ₁ of the first reinforced fiber bundle layer 102=+45°, fiber orientation θ₂ of the second reinforced fiber bundle layer 103==45°).

Furthermore, the reinforced fiber bundle layers 102 and 103 are fixed to each other by fixing elements 105 present in fixing portions 104.

FIG. 1 shows an example in which the fixing portions 104 are arranged to be positioned at the intersections of a square grid, and five fixing regions 106 are provided in the rectangular reinforced fiber laminate sheet 101. Fixing materials 107 present between the reinforced fiber bundle layers but not involved in fixation, are not fixing elements and do not bind the reinforced fibers together.

The reinforced fiber laminate sheet according to a first aspect satisfies conditions (i) and (ii):

(i) one or more fixing portions each including at least one fixing element present at a fixing surface between the first reinforced fiber bundle layer and the second reinforced fiber bundle layer have an average area S₁ of 100 mm² or less; and

(ii) in each of the fixing portions, an area rate of the fixing element to the fixing portion is 0.1% or more and 80% or less.

As for condition (i), when the average area S₁ is 100 mm² or less, preferably 80 mm² or less, more preferably 60 mm² or less, the area of the portion where the reinforced fiber bundles are bound together is small, the sheet is easily deformed, and the drapability is improved. The lower limit of the average area S₁ is not particularly limited, but the area of the fixing portion is preferably at least 0.01 mm² that is the minimum detectable size of the fixing element, and is more preferably 1 mm² or more. This is because if the fixing portion is extremely small and includes a small number of fixing elements inside, the fixing elements may exert weak binding force on the reinforced fibers at the fixing surface.

As for condition (ii), in each of the fixing portions, the area rate of the fixing element to the fixing portion is preferably 0.1% or more and 80% or less, more preferably 0.1% or more and 50% or less. When the area rate is within the above-mentioned range, it is possible to avoid binding all the reinforced fiber bundles together so that the strain generated in the reinforced fiber bundles at the time the reinforced fiber laminate sheet is deformed can be eliminated by freely deforming the cross-sectional shape of the reinforced fiber bundles, and it is possible to further improve the drapability of the reinforced fiber laminate sheet. The “area of a fixing element” means the area of a fixing element obtained by projecting the fixing element on the surface of the reinforced fiber laminate sheet from a direction perpendicular to the surface.

The area of fixing elements can be determined by delaminating the reinforced fiber bundle layers that constitute the reinforced fiber laminate sheet from each other, photographing the fixing elements attached to the reinforced fibers with a digital microscope, and binarizing the captured images. The areas of fixing portions and fixing regions are measured by the following measurement methods. More specifically, the reinforced fiber bundle layers having different orientations from each other that constitute the reinforced fiber laminate sheet are delaminated from each other, the fixing elements are distinguished by the above-mentioned method, and the positions of the fixing elements are determined. From the obtained positions of the fixing elements, the areas of the fixing portions and the fixing elements are calculated based on the definitions of the fixing portion and the fixing region described above.

The reinforced fiber laminate sheet according to a second aspect satisfies conditions (i) and (iii):

(i) one or more fixing portions each including at least one fixing element present at a fixing surface between the first reinforced fiber bundle layer and the second reinforced fiber bundle layer have an average area S₁ of 100 mm² or less; and

(iii) the fixing element is a particulate or fiber assembly-shaped resin that is melted.

Condition (i) is as described above.

As for condition (iii), since the fixing element is a particulate or fiber assembly-shaped resin that is melted, it is possible to bind the reinforced fiber bundle layers together via the fixing element that is a molten resin and to handle the reinforced fiber laminate sheet as a sheet, and form stability is improved. The “fiber assembly-shaped resin” means an assembly of one or more fibers of a resin. That is, only one fiber of a resin is also included in the “fiber assembly-shaped resin”. Furthermore, use of a meltable resin makes it possible to bind the reinforced fiber bundles only at the fixing portions, for example, by partial heating with an indenter on a protrusion.

In the reinforced fiber laminate sheet, the fixing element may be, for example, derived from a fixing material attached to a reinforced fiber bundle that constitutes a reinforced fiber bundle layer, or derived from a fixing material applied or placed after the formation of a reinforced fiber bundle layer. In either case, when a plurality of reinforced fiber bundle layers are arranged to have different fiber orientations from each other, and then at least a specific position described later is heated, it is possible to melt the fixing material present between the plurality of reinforced fiber bundle layers and realize a state in which at least one fixing element is arranged in a fixing portion in a specific form described later.

It is preferable in the reinforced fiber laminate sheet that the reinforced fiber laminate sheet have a fixing region including at least one of the fixing portions at the fixing surface between the first reinforced fiber bundle layer and the second reinforced fiber bundle layer, and an area rate of the fixing region to the reinforced fiber laminate sheet be 30% or more and 100% or less. With this configuration, particularly the form stability and the handling property of the reinforced fiber laminate sheet are easily improved. The “area of the fixing region” means the total area of all the fixing regions included in the reinforced fiber laminate sheet.

In the reinforced fiber laminate sheet, the average area S₂ of the fixing regions is preferably 10,000 mm² or more. When the average area S₂ of the fixing regions is 10,000 mm² or more, particularly the form stability and the handling property of the reinforced fiber laminate sheet are easily improved.

The reinforced fiber laminate sheet preferably has at least one fixing region in which an area rate of one or more fixing portions to the fixing region is 1% or more and 50% or less. The area rate of the fixing portions to the fixing region is more preferably 1% or more and 25% or less, still more preferably 5% or more and 20% or less. When the area rate of the fixing portions to the fixing region is 1% or more, the binding force between the reinforced fiber bundles or between the reinforced fiber bundle layers is strong, and the form stability of the reinforced fiber laminate sheet is improved. On the other hand, when the area rate is 50% or less, the binding force between the reinforced fiber bundle layers is weak, and the drapability of the reinforced fiber laminate sheet is improved. When the reinforced fiber laminate sheet has two or more fixing regions, the “area rate of the fixing portions to the fixing region” means the rate of the total area of the fixing portions present inside each fixing region to the area of the fixing region.

The reinforced fiber laminate sheet preferably further satisfies condition (iv):

(iv) the reinforced fiber laminate sheet has a fixing region in which centers of the fixing portions are arranged in a polygonal grid.

When the centers of the fixing portions are arranged in a polygonal grid, in draping of the reinforced fiber laminate sheet, the reinforced fiber laminate sheet is easily deformed with the orientation of the adjacent reinforced fibers keeping uniform positional relationship so that wrinkles or rucking is less likely to occur, and the drapability is improved. Even if fixing regions in which the centers of the fixing portions are arranged in a polygonal grid are partially present during the draping in some positions of the reinforced fiber laminate sheet where the reinforced fiber laminate sheet is easily wrinkled, the drapability is improved.

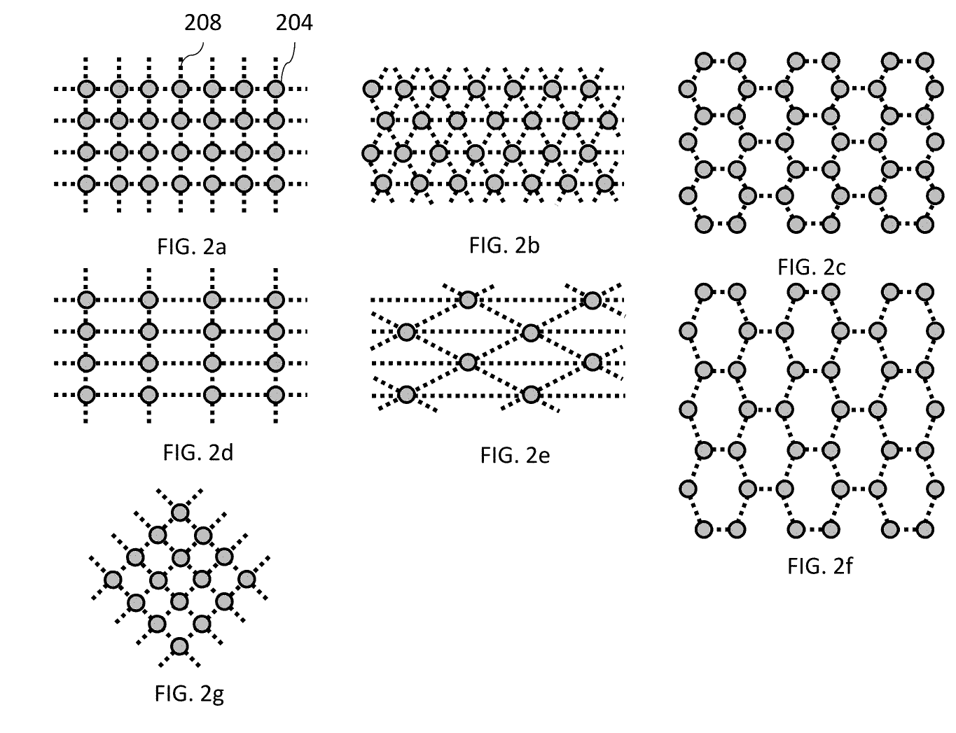

The phrase “centers of the fixing portions are arranged in a polygonal grid” means a state where fixing portions 204 are arranged in a grid 208 as shown in FIGS. 2a to 2g, for example. The grid may be a square grid (FIG. 2a), an equilateral triangular grid (FIG. 2b), a regular hexagonal grid (FIG. 2c), as well as a rectangular grid (FIG. 2d), a triangular grid (FIG. 2e), and a hexagonal grid (FIG. 2f). Examples of the grid also include a form of a grid obtained by rotating the above-mentioned forms (see, for example, FIG. 2g). The phrase “arranged in a grid” means a state where the centers of the fixing portions are arranged in a grid in a region of 50% or more, preferably 70% or more, more preferably 90% or more, still more preferably 100% of the fixing region, and the fixing region may partially include defects or the like.

The reinforced fiber laminate sheet preferably further satisfies condition (v):

(v) centers of the fixing portions are arranged in a regular polygonal grid having a side length L₁ (mm), and the length L₁ (mm) satisfies expression (1):

1≤L₁≤50 (1).

When 1≤L₁ is satisfied, since the adjacent fixing portions are arranged at a distance, adjacent reinforced fibers easily change the position and orientation uniformly during the draping, wrinkles or rucking is less likely to occur, and the drapability is easily improved. When L₁≤50 is satisfied, since the fixing portions are not too far apart from each other, and easily support unbound reinforced fibers, the form stability of the reinforced fiber laminate sheet is easily improved.

In the reinforced fiber laminate sheet, it is more preferable that the radius r (mm) of the fixing portion satisfy expression (3):

0.5≤r≤L₁/3 (3).

When 0.5≤r is satisfied, the binding force between the reinforced fibers is easily exerted by the fixing portion at the fixing surface, and the form stability of the reinforced fiber laminate sheet is easily improved. When r≤L₁/3 is satisfied, not too large fixing portions discretely bind the reinforced fibers together, adjacent reinforced fibers easily change the position and orientation uniformly during the draping, wrinkles or nicking is less likely to occur during the draping, and the drapability is easily improved.

Next, constituent elements of the reinforced fiber laminate sheet will be described.

The reinforced fiber laminate sheet is a reinforced fiber laminate sheet including: a first reinforced fiber bundle layer and a second reinforced fiber bundle layer each formed of a plurality of reinforced fiber bundles aligned in one direction, arranged to have different fiber orientations from each other, and in which reinforced fiber bundles between one layer have no direct binding force between each other, the first reinforced fiber bundle layer and the second reinforced fiber bundle layer being fixed to each other by a fixing element so that the first reinforced fiber bundle layer and the second reinforced fiber bundle layer are integrated with each other. The phrase “reinforced fiber bundle layers that are each formed of a plurality of reinforced fiber bundles aligned in one direction, and in which reinforced fiber bundles in one layer have no direct binding force between each other” means that the form of the reinforced fiber bundles in one layer is not retained by a weave structure or a knitted structure. In other words, the form of the reinforced fiber bundles in the first or second layer is retained by being fixed with the reinforced fiber bundles arranged in the second or first layer, respectively.

This configuration makes it possible to produce a substrate by the AFP, and the substrate is handleable and has both drapability and form stability.

The reinforced fiber bundle layers are each formed of a plurality of reinforced fiber bundles aligned in one direction, and the reinforced fiber bundles have no direct binding force between each other. In other words, only a single reinforced fiber bundle layer does not make up a sheet form, and cannot be handled. An example of the single reinforced fiber bundle layer is reinforced fiber bundles arranged in parallel on a table by the AFP. It is preferable not to use any auxiliary yarn or filling yarn since a reinforced fiber bundle layer in which, for example, an auxiliary yarn or a filling yarn is arranged in a direction orthogonal to the reinforced fiber bundles to bind the reinforced fiber bundles together reduces the desired effect such as improvement in the drapability and cost reduction.

In addition, the phrase that “the first and second reinforced fiber bundle layers have different fiber orientations from each other” means that the angle between the fiber orientation in the first reinforced fiber bundle layer and the fiber orientation in the second reinforced fiber bundle layer is 5° or more. The angle is preferably 10° or more, more preferably 20° or more. The angle is measured by observing the cross section of a substrate or a molded article. When it is impossible to destroy a molded article, the angle can be measured by transmission observation through X-ray CT scanning or the like.

The reinforced fiber bundle may be, for example, a mixture of a reinforced fiber with an organic fiber, an organic compound, or an inorganic compound, or a reinforced fiber to which a resin component is attached.

The reinforced fiber is not particularly limited, and examples thereof include carbon fibers, glass fibers, aramid fibers, alumina fibers, silicon carbide fibers, boron fibers, metal fibers, natural fibers, and mineral fibers. One of them or two or more of them may be used in combination. In particular, carbon fibers such as polyacrylonitrile (PAN)-based, pitch-based, and rayon-based carbon fibers are preferably used from the viewpoint of high specific strength and high specific rigidity as well as reduction in weight of the molded body. Alternatively, glass fibers can be preferably used from the viewpoint of enhancing the economic efficiency of the resulting molded article. Further, aramid fibers can be preferably used from the viewpoint of enhancing the shock absorbing property of the resulting molded article as well as the drapability. Alternatively, reinforced fibers coated with a metal such as nickel, copper, or ytterbium can also be used from the viewpoint of enhancing the conductivity of the resulting molded body.

In the fixing element, a heat-meltable resin that is capable of being reduced in viscosity by heating can be used. For example, it is possible to use the following resins: crystalline thermoplastic resins including polyesters such as polyethylene terephthalate, polybutylene terephthalate, polytrimethylene terephthalate, polyethylene naphthalate, and liquid crystalline polyesters, polyolefins such as polyethylene, polypropylene, and polybutylene, polyoxymethylene, polyamides, polyarylene sulfides such as polyphenylene sulfide, polyketone, polyether ketone, polyether ether ketone, polyether ketone ketone, polyether nitrile, fluororesins such as polytetrafluoroethylene, and liquid crystal polymers; amorphous thermoplastic resins including styrene resins, polycarbonate, polymethyl methacrylate, polyvinyl chloride, polyphenylene ether, polyimides, polyamide imide, polyether imide, polysulfone, polyether sulfone, and polyarylate; phenolic resins, phenoxy resins, epoxy resins, as well as thermoplastic elastomers such as polystyrene-based, polyolefin-based, polyurethane-based, polyester-based, polyamide-based, polybutadiene-based, polyisoprene-based, fluororesin, and acrylonitrile-based thermoplastic elastomers, copolymers and modified products of these, and resin blends of two or more of these resins. Depending on the intended use, it is also possible to use a mixture of a resin component with additives such as a filler, a conductivity imparting material, a flame retardant, and a flame retardant aid, or with interlayer reinforcing particles.

In the reinforced fiber laminate sheet, it is preferable that the fixing element be a heat-meltable resin, and that the heat-meltable resin have a glass transition temperature T_{g} (° C.) or a melting point Tₘ (° C.) of 40° C. or higher and 200° C. or lower. Such a resin fixes the reinforced fiber bundle layers together when the resin is reduced in viscosity by heating and then returned to normal temperature by cooling or the like, and a constant sheet form is more reliably retained.

As described above, the fixing element may be, for example, (A) a fixing material attached to a reinforced fiber bundle that constitutes a reinforced fiber bundle layer, or (B) a fixing material applied or placed after the formation of a reinforced fiber bundle layer. In (A), a reinforced fiber bundle to which a fixing material is attached can be obtained by attaching the above-mentioned resin in the form of particles, lines, bands or the like to the reinforced fiber bundle, or coating the reinforced fiber bundle with the above-mentioned resin. In (B), a reinforced fiber bundle layer to which a fixing material is applied or on which a fixing material is placed can be obtained by attaching, through spraying or the like, the above-mentioned resin in the form of particles, lines, bands or the like to at least one of the reinforced fiber bundle layers, or by placing a nonwoven fabric, a film, a knitted fabric, a woven fabric, or a net-shaped material made from the above-mentioned resin on at least one of the reinforced fiber bundle layers.

In the reinforced fiber laminate sheet, the fixing elements preferably have an average diameter φ (μm) of 10 μm or more and 500 μm or less. The average diameter φ (m) is more preferably 100 μm or more and 300 μm or less. With this configuration, the form stability of the reinforced fiber laminate sheet can be maintained while further improving the deformability of the reinforced fiber laminate sheet.

In the reinforced fiber laminate sheet, the thickness t_{f} (mm) of a reinforced fiber bundle and the thickness t₁ (mm) of a fixing element in the fixing portion preferably satisfy expression (2):

0.01≤t₁/t_{f}≤0.8 (2).

When the thicknesses satisfy expression (2), it is possible to avoid binding all the reinforced fiber bundles together so that the strain generated in the reinforced fiber bundles at the time the reinforced fiber laminate sheet is deformed can be eliminated by freely deforming the cross-sectional shape of the reinforced fiber bundles, and it is possible to further improve the drapability of the reinforced fiber laminate sheet. The “thickness” of a reinforced fiber bundle or a fixing element means the length of the reinforced fiber bundle or the fixing element in the direction perpendicular to the surface of the reinforced fiber laminate sheet.

t₁ and t_{f} are measured in the following manner. Fixing elements in the reinforced fiber laminate sheet are distinguished by the above-mentioned method using a digital microscope (VHX-1000 manufactured by Keyence Corporation). Then, the thicknesses of 10 or more reinforced fiber bundles that constitute the reinforced fiber laminate sheet are measured by changing the focal length of the digital microscope, and the average t₁ of the thicknesses is obtained. Then, the thicknesses of the fixing elements present at the measurement sites are measured, and the average t_{f} of the thicknesses is obtained.

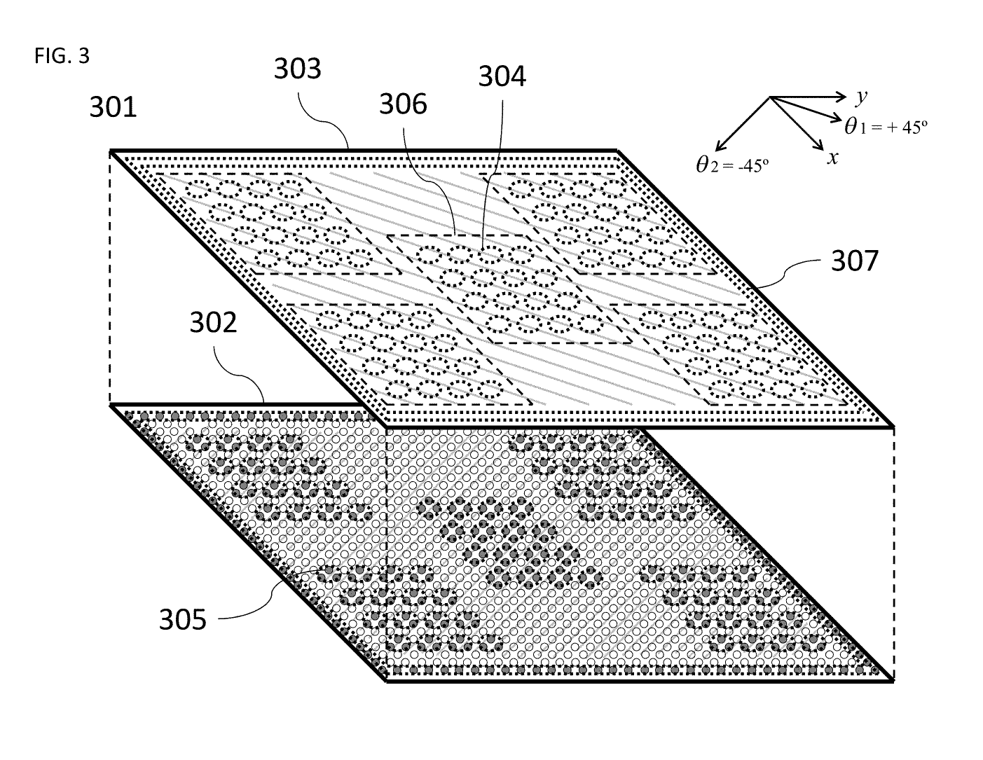

Further, FIG. 3 shows another example of a reinforced fiber laminate sheet 301.

In this example, in an end of the reinforced fiber laminate sheet 301, frame-shaped fixing regions 307 in which reinforced fiber bundle layers 302 and 303 are each fixed in a band shape are provided so that the frame-shaped fixing regions surround fixing regions 306 that include fixing portions 304 including fixing elements 305. With this configuration, fraying and disturbance of the reinforced fiber bundles at the end of the reinforced fiber laminate sheet, which is a problem of a substrate obtained by the AFP, can be further suppressed.

Next, the fiber-reinforced resin molded body will be described.

The fiber-reinforced resin molded body is made from the reinforced fiber laminate sheet and a matrix resin. Such a fiber-reinforced resin molded body can be manufactured, for example, by impregnating the reinforced fiber laminate sheet with a matrix resin.

As a method of impregnating the reinforced fiber laminate sheet with a matrix resin, the RTM can be used. More specifically, the RTM is a method of obtaining a molded body in the following manner: placing, in a cavity formed by an upper die and a lower die of a molding die, a reinforced fiber laminate sheet draped into the shape of the cavity, clamping the molding die, pressurizing the molding die to make the inside of the cavity substantially vacuum, then injecting a matrix resin into the cavity, and further heating the matrix resin to solidify.

The matrix resin used in the fiber-reinforced resin molded body may be a so-called thermoplastic resin, but the matrix resin is preferably a thermosetting resin. The resin may be, for example, an epoxy resin, an unsaturated polyester resin, a vinyl ester resin, a phenolic resin, a urea resin, a melamine resin, a polyimide resin, a copolymer or a modified product of these, or a blend of two or more of these resins. Among them, an epoxy resin is preferably used from the viewpoint of mechanical properties of the resulting molded body.

Then, a method of manufacturing a reinforced fiber laminate sheet will be described.

The method of manufacturing a reinforced fiber laminate sheet includes steps (a) to (c):

(a) a first reinforced fiber bundle layer arrangement step of arranging a plurality of reinforced fiber bundles aligned in one direction on a table to give a first reinforced fiber bundle layer in which the reinforced fiber bundles have no direct binding force between each other;

(b) a second reinforced fiber bundle layer arrangement step of further arranging, on the first reinforced fiber bundle layer, a plurality of reinforced fiber bundles aligned in one direction that is different from a fiber direction of the first reinforced fiber bundle layer to give a second reinforced fiber bundle layer in which the reinforced fiber bundles have no direct binding force between each other, and thus producing a reinforced fiber laminate; and

(c) a sheet forming step of obtaining a reinforced fiber laminate sheet satisfying conditions (i) and (ii) or (i) and (iii) using a sheet forming mechanism of partially heating and/or pressurizing the reinforced fiber laminate via a protrusion on a surface in contact with the reinforced fiber laminate to melt a fixing material between the first reinforced fiber bundle layer and the second reinforced fiber bundle layer:

(i) the reinforced fiber laminate sheet has one or more fixing portions each including at least one fixing element at a fixing surface between the first reinforced fiber bundle layer and the second reinforced fiber bundle layer, and the fixing portions have an average area S₁ of 100 mm² or less;

(ii) in each of the fixing portions, an area rate of the fixing element to the fixing portion is 0.1% or more and 80% or less; and

(iii) the fixing element is a particulate or fiber assembly-shaped fixing material that is melted.

Hereinafter, desirable examples will be described with reference to the drawings. It should be noted that this disclosure is not limited to the examples shown in the drawings.

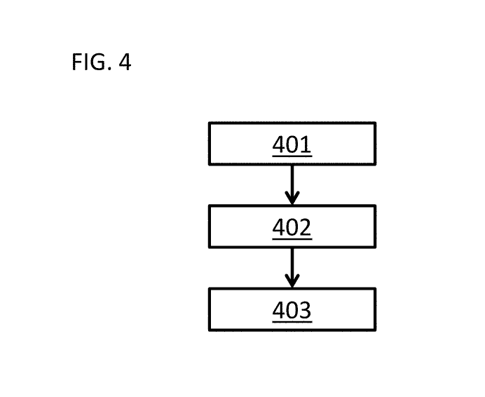

FIG. 4 is a flowchart showing one example of a method of manufacturing a reinforced fiber laminate sheet.

In the example shown in FIG. 4, as a first step, a first reinforced fiber bundle layer arrangement step (401) is performed, the step being a step of arranging aligned reinforced fiber bundles on a table to give a first reinforced fiber bundle layer.

Then, as a second step, a second reinforced fiber bundle layer arrangement step (402) is performed, the step being a step of further arranging, on the first reinforced fiber bundle layer, a second reinforced fiber bundle layer to give a reinforced fiber laminate.

Further, as a third step, a sheet forming step (403) is performed, the step being a step of obtaining a reinforced fiber laminate sheet satisfying conditions (i) and (ii) or (i) and (iii) using a sheet forming mechanism of partially heating and/or pressurizing the reinforced fiber laminate via a protrusion on a surface in contact with the reinforced fiber laminate to melt a fixing material.

The method of manufacturing a reinforced fiber laminate sheet includes (a) a first reinforced fiber bundle layer arrangement step of arranging a plurality of reinforced fiber bundles aligned in one direction on a table to give a first reinforced fiber bundle layer in which the reinforced fiber bundles have no direct binding force between each other. In the first reinforced fiber bundle layer arrangement step, as described above, it is preferable to employ a method of arranging the reinforced fiber bundles in parallel on the table by the AFP.

The method of manufacturing a reinforced fiber laminate sheet includes (b) a second reinforced fiber bundle layer arrangement step of further arranging, on the first reinforced fiber bundle layer, a plurality of reinforced fiber bundles aligned in one direction different from a fiber direction of the first reinforced fiber bundle layer to give a second reinforced fiber bundle layer in which the reinforced fiber bundles have no direct binding force between each other, and thus producing a reinforced fiber laminate. In the second reinforced fiber bundle layer arrangement step, for example, it is possible to align reinforced fiber bundles in one direction on the first reinforced fiber bundle layer to form a second reinforced fiber bundle layer, or to convey a reinforced fiber bundle layer preliminarily formed on another table and arrange the reinforced fiber bundle layer on the first reinforced fiber bundle layer.

The method of manufacturing a reinforced fiber laminate sheet includes (c) a sheet forming step of obtaining a reinforced fiber laminate sheet satisfying conditions (i) and (ii) or (i) and (iii) using a sheet forming mechanism of partially heating and/or pressurizing the reinforced fiber laminate via a protrusion on a surface in contact with the reinforced fiber laminate to melt a fixing material between the first reinforced fiber bundle layer and the second reinforced fiber bundle layer.

When this procedure is performed, it is possible to avoid binding all the reinforced fiber bundles together so that the strain generated in the reinforced fiber bundles at the time the reinforced fiber laminate sheet is deformed can be eliminated by freely deforming the cross-sectional shape of the reinforced fiber bundles, and it is possible to further improve the drapability of the reinforced fiber laminate sheet.

Then, constituent elements of the method of manufacturing a reinforced fiber laminate sheet will be described.

The table may be any table as long as it can at least maintain the arranged reinforced fiber bundles so as not to move. It is preferable that the table have means of adsorbing and holding the reinforced fiber bundles, and that the means have a mechanism based on electrostatic attraction and/or a mechanism based on attractive force generated by flow of air. Use of such a table makes it possible to more reliably hold the reinforced fiber bundles without displacement of the arranged reinforced fiber bundles having no direct binding force.

In the method of manufacturing a reinforced fiber laminate sheet, in step (c), a sheet forming mechanism is used, the sheet forming mechanism being a mechanism of partially heating and/or pressurizing the reinforced fiber laminate via a protrusion on a surface in contact with the reinforced fiber laminate to melt a fixing material.

Specific examples of the sheet forming mechanism include a mechanism of heating and/or pressurizing the reinforced fiber laminate with a flat plate-shaped indenter or roller having a protrusion. Use of this sheet forming mechanism melts the fixing material present between the plurality of reinforced fiber bundle layers to realize a state in which at least one fixing element is arranged in the fixing portion in a specific form described later. Then, a portion where the sheet forming mechanism is applied to the reinforced fiber bundle layer serves as a fixing region, and a portion where the protrusion actually comes into contact with the reinforced fiber bundle layer basically serves as a fixing portion.

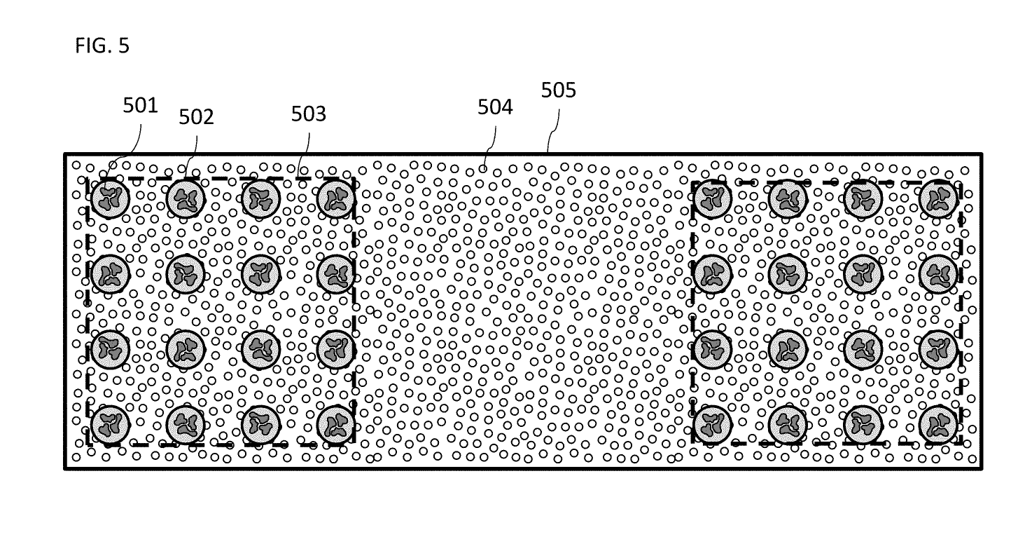

FIG. 5 is a schematic view for illustrating a relationship among fixing elements, fixing portions, and fixing regions as viewed from the viewpoint of the method of manufacturing a reinforced fiber laminate sheet. On a first reinforced fiber bundle layer 505, fixing materials 504 are arranged. The reinforced fiber laminate is heated and/or pressurized by a sheet forming mechanism from above a second reinforced fiber bundle layer (not shown) arranged on the fixing materials 504. At this time, a portion heated and/or pressurized by a sheet forming mechanism serves as a fixing region 503, and a portion where the protrusion of the sheet forming mechanism comes into contact with the reinforced fiber laminate serves as a fixing portion 502. Further, the fixing materials 504 in the fixing portions 502 melt and serve as fixing elements 501 that contribute to interlaminar fixing.

The “drapability” means a property that the reinforced fiber laminate sheet is easy to follow a three-dimensional mold without generation of wrinkles of the sheet or nicking of the fibers. The “form stability” means a property that the reinforced fiber bundles are not delaminated from each other and remain being bound together even in draping, and are capable of retaining the integrity as a sheet. The drapability and form stability are both evaluated by the methods described later.

It is preferable in the method of manufacturing a reinforced fiber laminate sheet that the reinforced fiber laminate sheet have a fixing region including at least one of the fixing portions at the fixing surface between the first reinforced fiber bundle layer and the second reinforced fiber bundle layer, and an area rate of the fixing region to the reinforced fiber laminate sheet be 30% or more and 100% or less. With this configuration, particularly the form stability and the handling property of the reinforced fiber laminate sheet are easily improved.

In the method of manufacturing a reinforced fiber laminate sheet, the average area S₂ of the fixing regions is preferably 10,000 mm² or more. When the average area S₂ of the fixing regions is 10,000 mm² or more, particularly the form stability and the handling property of the reinforced fiber laminate sheet are easily improved.

In the method of manufacturing a reinforced fiber laminate sheet, the reinforced fiber laminate sheet preferably has at least one fixing region in which an area rate of one or more fixing portions to the fixing region is 1% or more and 50% or less. The area rate of the fixing portions to the fixing region is more preferably 1% or more and 25% or less, still more preferably 5% or more and 20% or less. When the area rate of the fixing portions to the fixing region is 1% or more, the binding force between the reinforced fiber bundles or between the reinforced fiber bundle layers is strong, and the form stability of the reinforced fiber laminate sheet is improved. On the other hand, when the area rate is 50% or less, the binding force between the reinforced fiber bundle layers is weak, and the drapability of the reinforced fiber laminate sheet is improved. When the reinforced fiber laminate sheet has two or more fixing regions, the area rate of the fixing portions to the fixing region is the rate of the total area of the fixing portions present inside each fixing region in the area of the fixing region.

As described above, the method of manufacturing a reinforced fiber laminate sheet preferably further satisfies condition (iv):

(iv) the reinforced fiber laminate sheet has a fixing region in which centers of the fixing portions are arranged in a polygonal grid.

When the centers of the fixing portions are arranged in a polygonal grid, as described above, in draping of the reinforced fiber laminate sheet, the reinforced fiber laminate sheet is easily deformed with the orientation of the adjacent reinforced fibers keeping uniform positional relationship so that wrinkles or rucking is less likely to occur, and the drapability is improved. Even if fixing regions in which the centers of the fixing portions are arranged in a polygonal grid are partially present during the draping in some positions of the reinforced fiber laminate sheet where the reinforced fiber laminate sheet is easily wrinkled, the drapability is improved.

The method of manufacturing a reinforced fiber laminate sheet preferably further satisfies condition (v):

(v) centers of the fixing portions are arranged in a regular polygonal grid having a side length L₁ (mm), and the length L₁ (mm) satisfies expression (1):

1≤L₁≤50 (1).

As described above, when the length L₁ (mm) is 1 mm or more, the binding force between the reinforced fiber bundle layers can be weakened, and the drapability of the reinforced fiber laminate sheet is easily improved. On the other hand, when the length L₁ is 50 mm or less, the binding force between the reinforced fiber bundles or between the reinforced fiber bundle layers can be strengthened, and the form stability of the reinforced fiber laminate sheet is easily improved.

In the method of manufacturing a reinforced fiber laminate sheet, it is more preferable that the radius r (mm) satisfy expression (3):

0.5≤r≤L₁/3 (3).

When the radius r is 0.5 or more, the binding force between the reinforced fibers is easily exerted by the fixing portion at the fixing surface, and the form stability of the reinforced fiber laminate sheet is easily improved. In addition, when the radius r is L₁/3 or less, not too large fixing portions discretely bind the reinforced fibers together, adjacent reinforced fibers easily change the position and orientation uniformly during the draping, wrinkles or nicking is less likely to occur during the draping, and the drapability is easily improved.

The method of manufacturing a reinforced fiber laminate sheet preferably includes step (a1) between steps (a) and (b):

(a1) a fixing material placement step of placing a fixing material on the first reinforced fiber bundle layer.

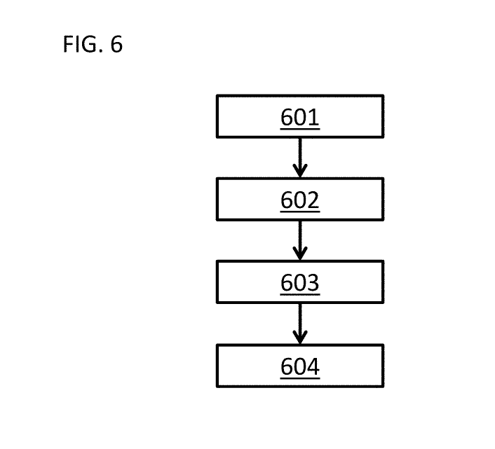

FIG. 6 is a flowchart showing another example of the method of manufacturing a reinforced fiber laminate sheet, the method including step (a1).

In this example, a fixing material placement step (602) of placing a fixing material on the first reinforced fiber bundle layer is performed between a first reinforced fiber bundle layer arrangement step (601) and a second reinforced fiber bundle layer arrangement step (603).

When the method of manufacturing a reinforced fiber laminate sheet includes step (a1) between steps (a) and (b), it is possible to place a more appropriate amount of the fixing material, and the reinforced fiber laminate sheet can more reliably exert the function as designed.

When the method includes step (a1), the fixing material can be placed by attaching, through spraying or the like, the above-mentioned heat-meltable resin in the form of particles, lines, bands or the like to the first reinforced fiber bundle layer or a surface of the second reinforced fiber bundle layer in contact with the first reinforced fiber bundle layer, or by placing a nonwoven fabric, a film, a knitted fabric, a woven fabric, or a net-shaped material made from the above-mentioned heat-meltable resin on the above-mentioned site.

In the method of manufacturing a reinforced fiber laminate sheet, the reinforced fiber bundles in step (a) and/or step (b) are preferably reinforced fiber bundles to which a fixing material is attached. When the reinforced fiber bundles are reinforced fiber bundles to which a fixing material is attached, the reinforced fiber bundles are more rigid, the form change of the reinforced fiber bundles at the time of arrangement is suppressed, and the uniformity of the reinforced fiber bundle layers is improved. As described above, the reinforced fiber bundles to which a fixing material is attached can be obtained, for example, by attaching the above-mentioned resin in the form of particles, lines, bands or the like to the reinforced fiber bundles, or coating the reinforced fiber bundles with the above-mentioned resin.

The method of manufacturing a reinforced fiber laminate sheet preferably includes step (d) simultaneously with or after step (c):

(d) a fixing frame forming step of forming a fixing frame in at least a part of an end of the reinforced fiber laminate sheet.

When the method includes step (d) before step (c), the fixing frame formed in step (d) is sometimes displaced in step (c). Thus, the method preferably includes step (d) simultaneously with or after step (c). Further, when the method includes step (d), a fixing frame fixed in a line or band shape is formed in an end of the reinforced fiber laminate sheet, and fraying and disturbance of the reinforced fiber bundles at the end of the reinforced fiber laminate sheet, which is a problem of a substrate obtained by the AFP, can be further suppressed.

### EXAMPLES

Hereinafter, our sheets, molded bodies and methods will be described in more detail with reference to examples, but this disclosure is not limited to the examples.

First, the drapability and form stability of the reinforced fiber laminate sheet, and evaluation of the fiber-reinforced resin molded body will be described.

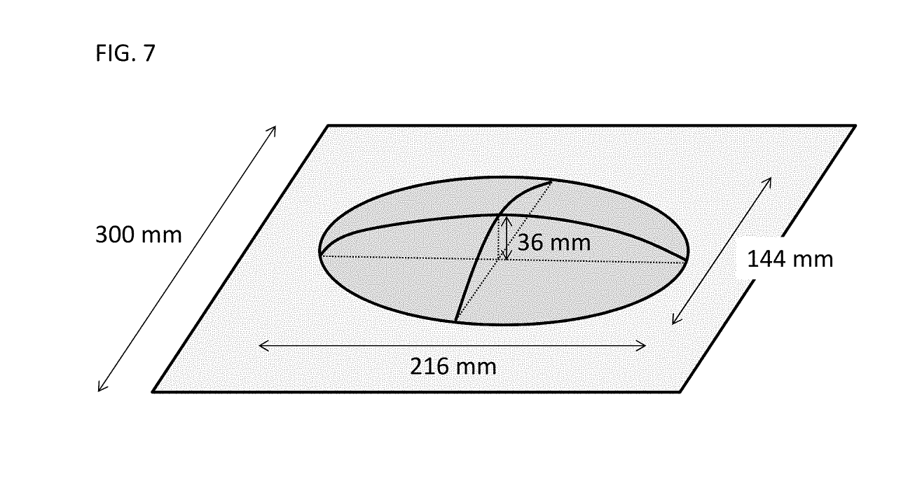

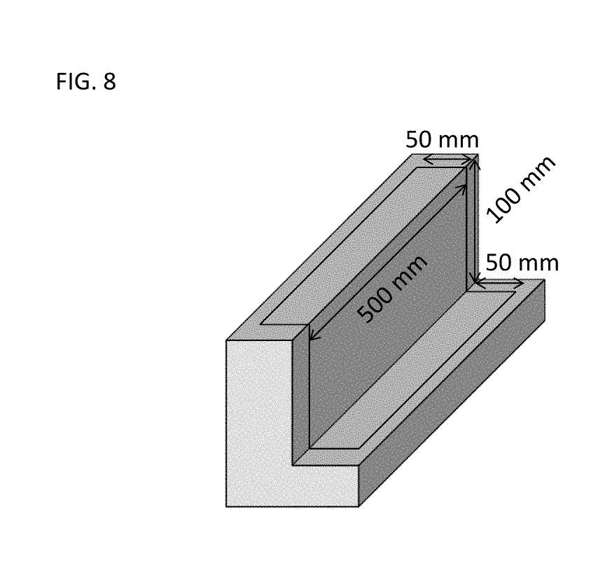

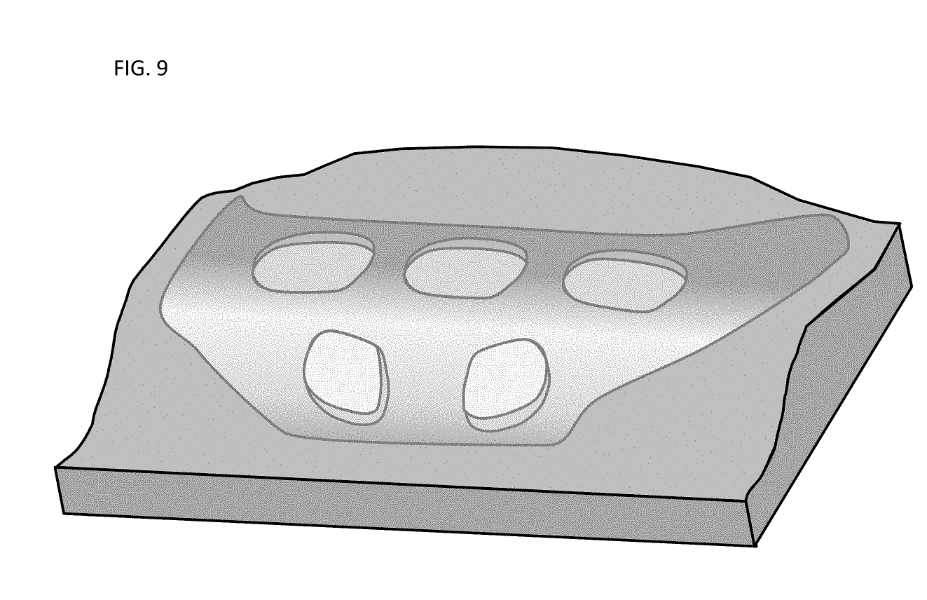

The drapability of the reinforced fiber laminate sheet was evaluated in the following three items: draping in a simple element shape die (FIG. 7) that is a shape obtained by cutting an oval sphere in the horizontal direction, a model shape die 1 (FIG. 8) simulating the shape of a Z-type stringer used in a skin/stringer structure of aircraft, and a model shape die 2 (FIG. 9) simulating the shape of a trunk lid of an automobile. The evaluation criteria for the drapability of the reinforced fiber laminate sheet are shown below.

AA: No wrinkle

A: 4 or less wrinkles in the out-of-plane direction

B: 5 or more and 10 or less wrinkles in the out-of-plane direction

C: 10 or more wrinkles in the out-of-plane direction

In addition, the evaluation criteria for the form stability of the reinforced fiber laminate sheet are shown below.

AA: No delamination

A: Gap between delaminated reinforced fiber bundles is less than 3 mm at maximum

B: Gap between delaminated reinforced fiber bundles is 3 mm or more and less than 5 mm at maximum

C: Gap between delaminated reinforced fiber bundles is 5 mm or more at maximum

Meanwhile, as for the evaluation of the fiber-reinforced resin molded body, a fiber-reinforced resin molded body obtained by molding, by the RTM, a preform in the form of the model shape die 1 or 2 was used. The fiber-reinforced resin molded body was visually observed and evaluated based on the degree of occurrence of defects such as wrinkles in the reinforced fiber bundle layers in the molded body. The evaluation criteria for the fiber-reinforced resin molded body are shown below.

AA: No defects such as wrinkles

A: 4 or less defects such as wrinkles

B: 5 or more and 10 or less defects such as wrinkles

C: 10 or more defects such as wrinkles

### Reference Example 1 Reinforced Fiber Bundle 1

A carbon fiber “Torayca” T700SC (number of single yarns: 24,000) manufactured by Toray Industries, Inc. was spread with a fiber spreading machine having a fiber spreading roller so that the fiber would have a width of 25 mm. Then, a fixing material made from a bisphenol A epoxy resin (XB3366 manufactured by Huntsman, T_{g}: 80° C.) having an average particle size of 150 μm was attached to the carbon fiber at a rate of 4 wt % based on the weight of the carbon fiber. Further, the carbon fiber to which the fixing material was attached was heated at 200° C. in a heating apparatus to melt part of the fixing material so that the fixing material would not fall of in the subsequent steps, whereby a reinforced fiber bundle 1 was obtained.

### Reference Example 2 Matrix Resin

A two-component epoxy resin (base resin: jER 828 manufactured by Mitsubishi Chemical Corporation, curing agent: an acid anhydride curing agent manufactured by Toray Industries, Inc.) was used as a matrix resin.

### Reference Example 3 Indenter Plate 1

A copper indenter plate that has round protrusions each having a radius (r) of 2.5 mm and a height of 1 mm arranged at apex positions of a square grid having a side length (L₁) of 20 mm (L₁/3=6.7 mm).

### Reference Example 4 Indenter Plate 2

A copper indenter plate that has square protrusions each having a side length of 7.07 mm and a height of 1 mm arranged at apex positions of a square grid having a side length (L₁) of 20 mm (L₁/3=6.7 mm). In this indenter plate, the radius (r) is 5.0 mm.

### Reference Example 5 Indenter Plate 3

A copper indenter plate that has round protrusions each having a radius (r) of 1.25 mm and a height of 1 mm arranged at apex positions of a square grid having a side length (L₁) of 5 mm (L₁/3=1.7 mm).

### Reference Example 6 Indenter Plate 4

A Copper Indenter Plate that has Round Protrusions Each Having a Radius (r) of 2.5 mm and a height of 1 mm arranged at apex positions of an equilateral triangular grid having a side length (L₁) of 20 mm (L₁/3=6.7 mm).

### Reference Example 7 Indenter Plate 5

A copper indenter plate that has round protrusions each having a radius (r) of 2.5 mm and a height of 1 mm arranged at apex positions of a regular hexagonal grid having a side length (L₁) of 20 mm (L₁/3=6.7 mm).

### Reference Example 8 Indenter Plate 6

A copper indenter plate that has round protrusions each having a radius (r) of 2.5 mm and a height of 1 mm arranged at random positions.

### Reference Example 9 Indenter Plate 7

A copper indenter plate that has round protrusions each having a radius (r) of 2.5 mm and a height of 1 mm arranged at apex positions of a square grid having a side length (L₁) of 5 mm (L₁/3=1.7 mm).

### Reference Example 10 Flat Plate 1

A copper flat plate that does not have protrusions unlike the indenter plates 1 to 7.

### Example 1

The reinforced fiber bundles 1 obtained in Reference Example 1 aligned in one direction were arranged by an AFP apparatus on a table capable of adsorbing and holding reinforced fiber bundles by a mechanism based on electrostatic attraction to produce a reinforced fiber bundle layer (reinforced fiber bundle layers 1 to 8). Table 1 shows the produced reinforced fiber bundle layers for each shape. Those used for the evaluation of drapability of the reinforced fiber laminate sheet in a simple element shape die were reinforced fiber bundle layers 1 and 2 having a size of 300 mm×300 mm, those used for the evaluation of drapability of the reinforced fiber laminate sheet in a model shape die 1 were reinforced fiber bundle layers 3 and 4 having a size of 500 mm×200 mm, and those used for the evaluation of drapability of the reinforced fiber laminate sheet in a model shape die 2 were reinforced fiber bundle layers 5 to 8 having a size of 1.8 m×1.3 m and corresponding to the model shape die 2.

### Evaluation of Drapability of Reinforced Fiber Laminate Sheet in Simple Element Shape Die

After one reinforced fiber bundle layer 1 was arranged on the table, a reinforced fiber bundle layer 2 for the second layer was arranged to form an angle of 90° with the fiber orientation angle of the reinforced fiber bundles in the first layer.

Then, the indenter plate 1 (area rate of the fixing portions to the fixing region: 5%) heated to 150° C. was pressed against the resulting laminate so that the pressure on the protrusion portions would be 120 kPa for 3 seconds. In this way, only the protrusion portions arranged in a grid were fixed to form fixing portions, and a reinforced fiber laminate sheet (1A) was obtained. The portion pressed by the indenter plate 1, that is, the fixing region, accounted for 100% in area rate in the reinforced fiber laminate sheet. In the following examples, when a flat plate-shaped indenter having round protrusions was used, the area of the protrusions was taken as the area of the fixing portions.

Evaluation results of the drapability and form stability of the reinforced fiber laminate sheet are shown in Tables 2 and 3. No wrinkles or delamination was observed in the reinforced fiber laminate sheet after draping.

### Evaluation of Drapability of Reinforced Fiber Laminate Sheet in Model Shape Die 1

After one reinforced fiber bundle layer 3 was arranged on the table, a reinforced fiber bundle layer 4 for the second layer was arranged to form an angle of 90° with the fiber orientation angle of the reinforced fiber bundles in the first layer.

Then, the indenter plate 1 (area rate of the fixing portions to the fixing region: 5%) heated to 150° C. was pressed against the resulting laminate so that the pressure on the protrusion portions would be 120 kPa for 3 seconds. In this way, only the protrusion portions arranged in a grid were fixed to form fixing portions, and a reinforced fiber laminate sheet (1B) was obtained. The portion pressed by the indenter plate 1, that is, the fixing region, accounted for 100% in area rate in the reinforced fiber laminate sheet.

Evaluation results of the drapability and form stability of the reinforced fiber laminate sheet are shown in Tables 2 and 3. No wrinkles or delamination was observed in the reinforced fiber laminate sheet after draping.

### Evaluation of Molded Body Properties of Fiber-Reinforced Resin Molded Body in Model Shape Die 1

Four reinforced fiber laminate sheets (1B) were laminated on the model shape die 1, and were draped to give a preform. Then, the obtained preform was placed in a die heated to 130° C., the die was clamped and pressurized at 4 MPa to make the inside of the cavity substantially vacuum, and then the matrix resin of Reference Example 3 was injected into the cavity at an injection pressure of 0.1 MPa. After injection, the temperature and pressure of the die were maintained to sufficiently cure the matrix resin, the die was opened, and the resulting molded body was removed from the die to give a fiber-reinforced resin molded body (1C).

The evaluation results of the fiber-reinforced resin molded body are shown in Tables 2 and 3. As a result of visual check, no wrinkles of the reinforced fiber bundle layers were observed in the molded body, and the molded body was very satisfactory.

### Evaluation of Drapability of Reinforced Fiber Laminate Sheet in Model Shape Die 2

After one reinforced fiber bundle layer 5 was arranged on the table, a reinforced fiber bundle layer 6 for the second layer was arranged to form an angle of 90° with the fiber orientation angle of the reinforced fiber bundles in the first layer.

Then, the indenter plate 1 (area rate of the fixing portions to the fixing region: 5%) heated to 150° C. was pressed against the resulting laminate so that the pressure on the protrusion portions would be 120 kPa for 3 seconds. In this way, only the protrusion portions arranged in a grid were fixed to form fixing portions, and a reinforced fiber laminate sheet (1D) was obtained. The portion pressed by the indenter plate 1, that is, the fixing region, accounted for 100% in area rate in the reinforced fiber laminate sheet.

Evaluation results of the drapability and form stability of the reinforced fiber laminate sheet are shown in Tables 2 and 3. No wrinkles or delamination was observed in the reinforced fiber laminate sheet after draping.

### Evaluation of Molded Body Properties of Fiber-Reinforced Resin Molded Body in Model Shape Die 2

A reinforced fiber laminate sheet (1D-2) was produced similarly to the reinforced fiber laminate sheet (1D) except that after one reinforced fiber bundle layer 7 was arranged on the table, a reinforced fiber bundle layer 8 for the second layer was arranged to form an angle of 90° with the fiber orientation angle of the reinforced fiber bundles in the first layer. Four reinforced fiber laminate sheets (1D and 1D-2) were symmetrically laminated on each other on the actual shape model 2 and draped to give a preform. Then, the obtained preform was placed in a die heated to 130° C., the die was clamped and pressurized at 4 MPa to make the inside of the cavity substantially vacuum, and then the matrix resin of Reference Example 3 was injected into the cavity at an injection pressure of 0.1 MPa. After injection, the temperature and pressure of the die were maintained to sufficiently cure the matrix resin, the die was opened, and the resulting molded body was removed from the die to give a fiber-reinforced resin molded body (1E).

The evaluation results of the fiber-reinforced resin molded body are shown in Tables 2 and 3. As a result of visual check, no wrinkles of the reinforced fiber bundle layers were observed in the molded body, and the molded body was very satisfactory.

### Example 2

Reinforced fiber laminate sheets (2A), (2B), and (2D) as well as fiber-reinforced resin molded bodies (2C) and (2E) were obtained in the same manner as in Example 1 except that the indenter plate used in fixing the reinforced fiber bundle layers together was changed to the indenter plate 2 (area rate of the fixing portions to the fixing region: 10.7%).

The evaluation results of the reinforced fiber laminate sheets and the evaluation results of the fiber-reinforced resin molded bodies are shown in Table 2. As for the drapability and form stability, 1 wrinkle was observed in the simple element shape die (2A), 1 wrinkle was observed in the model shape die 1 (2B), and 1 wrinkle was observed and delamination of fiber bundles of 2 mm at maximum was observed at the end in the model shape die 2 (2C). However, no wrinkles or delamination that might cause problems was observed. The molded bodies were also visually checked. As a result, although 2 wrinkles of the reinforced fiber bundles were observed in the model shape die 1 (2D), and 2 wrinkles of the reinforced fiber bundles were observed in the model shape die 2 (2E), the obtained molded bodies were satisfactory.

### Example 3

Reinforced fiber laminate sheets (3A), (3B), and (3D) as well as fiber-reinforced resin molded bodies (3C) and (3E) were obtained in the same manner as in Example 1 except that the indenter plate used in fixing the reinforced fiber bundle layers together was changed to the indenter plate 3 (area rate of the fixing portions to the fixing region: 20%).

The evaluation results of the reinforced fiber laminate sheets and the evaluation results of the fiber-reinforced resin molded bodies are shown in Tables 2 and 3. As for the drapability and form stability, 2 wrinkles were observed in the simple element shape die (3A), 2 wrinkles were observed in the model shape die 1 (3B), and 2 wrinkles were observed and delamination of fiber bundles of 2 mm at maximum was observed at the end in the model shape die 2 (3C).

However, no wrinkles or delamination that might cause problems was observed. The molded bodies were also visually checked. As a result, although 3 wrinkles of the reinforced fiber bundle layers were observed in the model shape die 1 (3D), and 3 wrinkles of the reinforced fiber bundle layers were observed in the model shape die 2 (3E), the obtained molded bodies were satisfactory.

### Example 4

Reinforced fiber laminate sheets (4A), (4B), and (4D) as well as fiber-reinforced resin molded bodies (4C) and (4E) were obtained in the same manner as in Example 1 except that the indenter plate used in fixing the reinforced fiber bundle layers together was changed to the indenter plate 4 (area rate of the fixing portions to the fixing region: 6%).

The evaluation results of the reinforced fiber laminate sheets and the evaluation results of the fiber-reinforced resin molded bodies are shown in Tables 2 and 3. As for the drapability and form stability, 5 wrinkles were observed in the simple element shape die (4A), 6 wrinkles were observed and delamination of fiber bundles of 3 mm at maximum was observed at the end in the model shape die 1 (4B), and 6 wrinkles were observed and delamination of fiber bundles of 4 mm at maximum was observed at the end in the model shape die 2 (4C). However, no wrinkles or delamination that might cause problems was observed. The molded bodies were also visually checked. As a result, although 5 wrinkles of the reinforced fiber bundle layers were observed in the model shape die 1 (4D), and 6 wrinkles of the reinforced fiber bundle layers were observed in the model shape die 2 (4E), the obtained molded bodies were satisfactory.

### Example 5

Reinforced fiber laminate sheets (5A), (5B), and (5D) as well as fiber-reinforced resin molded bodies (5C) and (5E) were obtained in the same manner as in Example 1 except that the indenter plate used in fixing the reinforced fiber bundle layers together was changed to the indenter plate 5 (area rate of the fixing portions to the fixing region: 4%).

The evaluation results of the reinforced fiber laminate sheets and the evaluation results of the fiber-reinforced resin molded bodies are shown in Tables 2 and 3. As for the drapability and form stability, 2 wrinkles were observed in the simple element shape die (5A), 3 wrinkles were observed and delamination of fiber bundles of 2 mm at maximum was observed in the model shape die 1 (5B), and 3 wrinkles were observed and delamination of fiber bundles of 2 mm at maximum was observed at the end in the model shape die 2 (5C). However, no wrinkles or delamination that might cause problems was observed. The molded bodies were also visually checked. As a result, although 3 wrinkles of the reinforced fiber bundle layers were observed in the model shape die 1 (5D), and 3 wrinkles of the reinforced fiber bundle layers were observed in the model shape die 2 (5E), the obtained molded bodies were satisfactory.

### Example 6

Reinforced fiber laminate sheets (6A), (6B), and (6D) as well as fiber-reinforced resin molded bodies (6C) and (6E) were obtained in the same manner as in Example 1 except that the indenter plate used in fixing the reinforced fiber bundle layers together was changed to the indenter plate 6 (area rate of the fixing portions to the fixing region: 5%).

The evaluation results of the reinforced fiber laminate sheets and the evaluation results of the fiber-reinforced resin molded bodies are shown in Tables 2 and 3. As for the drapability and form stability, delamination of the reinforced fiber bundles occurred at many sites mainly at the end of the reinforced fiber laminate sheet, and delamination of 4 mm at maximum occurred in the simple element shape die (6A). Similar delamination occurred, delamination of 4 mm at maximum occurred, and 5 wrinkles in the out-of-plane direction occurred in the model shape die 1 (6B) and the model shape die 2 (6C). The molded bodies were also visually checked. As a result, although 8 wrinkles of the reinforced fiber bundle layers were observed in the model shape die 1 (6D), and 9 wrinkles of the reinforced fiber bundle layers were observed in the model shape die 2 (6E), the obtained molded bodies had no problem in use because all the wrinkles were generated at the end, that is, a region outside the product.

### Example 7

A reinforced fiber laminate sheet (7A) was obtained in the same manner as in Example 1 except that the following two fixing regions (R1) and (R2) were produced.

(R1) A region in the range of within 20 mm from the outer periphery of the reinforced fiber laminate sheet

(R2) A square region that is positioned at a site where the center of the reinforced fiber laminate sheet and the center of gravity of a 100 mm×100 mm square coincide with each other, and that has sides parallel to the outer periphery of the reinforced fiber laminate sheet.

The area rate of the fixing portions to the fixing region is 36%.

The evaluation results of the reinforced fiber laminate sheet are shown in Tables 4 and 5. As for the drapability and form stability, no wrinkles were observed, but delamination of fiber bundles of 4 mm at maximum was observed in the simple element shape die (7A).

### Comparative Example 1

Reinforced fiber laminate sheets (8A), (8B), and (8D) were obtained in the same manner as in Example 1 except that the indenter plate used in fixing the reinforced fiber bundle layers together was changed to the indenter plate 1 (fixing portions: whole sheet (the area of the fixing portions is the same as the sheet area (both 100 mm² or more)), area rate of the fixing portions to the fixing region: 100%).

The evaluation results of the reinforced fiber laminate sheets are shown in Tables 4 and 5. As for the drapability and form stability, although no delamination of fiber bundles was observed, part of the reinforced fiber laminate sheet was buckled in the out-of-plane direction, and overlapping wrinkles occurred in the simple element shape die (8A). Although no delamination of fiber bundles was observed, similar wrinkles occurred also in the model shape die 1 (8B) and the model shape die 2 (8C), and it was impossible to use the reinforced fiber laminate sheets for molding into a fiber-reinforced resin molded body.

### Comparative Example 2

Reinforced fiber laminate sheets (9A), (9B), and (9D) were obtained in the same manner as in Example 1 except that the indenter plate used in fixing the reinforced fiber bundle layers together was changed to the indenter plate 7 (area rate of the fixing portions to the fixing region: 79%).

The evaluation results of the reinforced fiber laminate sheets are shown in Tables 4 and 5. As for the drapability and form stability, although no delamination of fiber bundles was observed, part of the reinforced fiber laminate sheet was buckled in the out-of-plane direction, and overlapping wrinkles occurred in the simple element shape die (9A). Although no delamination of fiber bundles was observed, similar wrinkles occurred also in the model shape die 1 (9B) and the model shape die 2 (9C), and it was impossible to use the reinforced fiber laminate sheets for molding into a fiber-reinforced resin molded body.

### Comparative Example 3

A reinforced fiber laminate sheet (10A) was obtained in the same manner as in Example 1 except that the following one fixing region (R1) was produced.

(R1) A region in the range of within 20 mm from the outer periphery of the reinforced fiber laminate sheet

The area rate of the fixing portions to the fixing region is 25%.

The evaluation results of the reinforced fiber laminate sheet are shown in Tables 4 and 5. As for the drapability and form stability, 4 wrinkles occurred, delamination of the reinforced fiber bundles occurred at many sites in the unfixed region of the reinforced fiber laminate sheet, and delamination of 10 mm at maximum occurred at 5 or more sites in the simple element shape die (10A).

### Comparative Example 4

Reinforced fiber laminate sheets (11A), (11B), and (11D) were obtained in the same manner as in Example 1 except that in the step of applying the fixing material in Example 1, the application amount was doubled, and the area rate of the fixing element to the fixing portion was changed to 85%.

The evaluation results of the reinforced fiber laminate sheets are shown in Tables 4 and 5. As for the drapability and form stability, although no delamination of fiber bundles was observed, part of the reinforced fiber laminate sheet was buckled in the out-of-plane direction, and overlapping wrinkles occurred in the simple element shape die (11A). Although no delamination of fiber bundles was observed, similar wrinkles occurred also in the model shape die 1 (11B) and the model shape die 2 (11C), and it was impossible to use the reinforced fiber laminate sheets for molding into a fiber-reinforced resin molded body.

TABLE 2

| | Example 1 | Example 2 | Example 3 | Example 4 | Example 5 | Example 6 |
|---|---|---|---|---|---|---|
| Shape of indenter | Round | Square | Round | Round | Round | Round |
| Average area of fixing portions | 20 | 79 | 5 | 20 | 20 | 20 |
| (mm²) | | | | | | |
| Radius of fixing portion (mm) | 2.5 | 5.0 | 1.25 | 2.5 | 2.5 | 2.5 |
| Distance between centers of | 20 | 20 | 5 | 20 | 20 | 20 |
| fixing portions (mm) | | | | | | |
| Grid shape of fixing portions | Square | Square | Square | Equilateral | Regular | Random |
| | | | | triangle | hexagon | |
| Rate of fixing elements (%) | 43 | 43 | 43 | 43 | 43 | 43 |
| Rate of fixing portions (%) | 5 | 11 | 20 | 6 | 3 | 5 |
| Rate of fixing regions (%) | 100 | 100 | 100 | 100 | 100 | 100 |

TABLE 3

| | | Example 1 | Example 2 | Example 3 | Example 4 | Example 5 | Example 6 |
|---|---|---|---|---|---|---|---|
| Evaluation of | Drapability | AA | A | A | B | A | B |
| simple element | Form stability | AA | AA | A | B | A | B |
| shape die | | | | | | | |
| Evaluation of | Drapability | AA | A | A | B | A | B |
| model shape die 1 | Form stability | AA | AA | A | B | A | B |
| | Molded body | AA | A | A | B | B | B |
| Evaluation of | Drapability | AA | A | A | B | A | B |
| model shape die 2 | Form stability | AA | A | A | B | A | B |
| | Molded body | AA | A | A | B | B | B |

TABLE 4

| | | Comparative | Comparative | Comparative | Comparative |
|---|---|---|---|---|---|
| | Example 7 | Example 1 | Example 2 | Example 3 | Example 4 |
| Shape of indenter | Round | Round | Round | Round | Round |
| Average area of fixing | 20 | >100 | 20 | 20 | 20 |
| portions (mm²) | | | | | |
| Radius of fixing portion (mm) | 2.5 | Whole area | 2.5 | 2.5 | 2.5 |
| Distance between centers of | 20 | | 5 | 20 | 20 |
| fixing portions (mm) | | | | | |
| Grid shape of fixing portions | Square | | Square | Square | Square |
| Rate of fixing elements (%) | 43 | 43 | 43 | 43 | 85 |
| Rate of fixing portions (%) | 5 | 100 | 79 | 5 | 5 |
| Rate of fixing regions (%) | 36 | 100 | 100 | 25 | 100 |

TABLE 5

| | | | Comparative | Comparative | Comparative | Comparative |
|---|---|---|---|---|---|---|
| | | Example 7 | Example 1 | Example 2 | Example 3 | Example 4 |
| Evaluation of | Drapability | AA | C | C | A | C |
| simple element | Form stability | B | AA | AA | C | AA |
| shape die | | | | | | |
| Evaluation of | Drapability | — | C | C | — | C |
| model shape die 1 | Form stability | — | AA | AA | — | AA |
| | Molded body | — | — | — | — | — |
| Evaluation of | Drapability | — | C | C | — | C |
| model shape die 2 | Form stability | — | AA | AA | — | AA |
| | Molded body | — | | — | — | |

### INDUSTRIAL APPLICABILITY

The method of manufacturing a reinforced fiber laminate sheet is capable of providing a reinforced fiber laminate sheet that can be suitably used even if a fiber reinforced plastic molded body has a shape having a complicated curved surface.

Furthermore, the fiber-reinforced resin molded body produced from the reinforced fiber laminate sheet is suitable for primary structural members, secondary structural members, and exterior and interior components in transportation equipment such as aircraft members, automobile members, and automatic two-wheel vehicle members, and members for general industrial use such as windmill blades, robot arms, and medical equipment such as X-ray top panels.

1.-17. (canceled)

18. A reinforced fiber laminate sheet comprising: a first reinforced fiber bundle layer and a second reinforced fiber bundle layer each formed of a plurality of reinforced fiber bundles aligned in one direction, arranged to have different fiber orientations from each other, and in which reinforced fiber bundles in one layer have no direct binding force between each other, the first reinforced fiber bundle layer and the second reinforced fiber bundle layer being fixed to each other by a fixing element so that the first reinforced fiber bundle layer and the second reinforced fiber bundle layer are integrated with each other, the reinforced fiber laminate sheet satisfying conditions (i) and (ii):
(i) the reinforced fiber laminate sheet has one or more fixing portions each including at least one fixing element at a fixing surface between the first reinforced fiber bundle layer and the second reinforced fiber bundle layer, and the fixing portions have an average area S₁ of 100 mm² or less; and
(ii) in each of the fixing portions, an area rate of the fixing element to the fixing portion is 0.1% or more and 80% or less.

19. A reinforced fiber laminate sheet comprising: a first reinforced fiber bundle layer and a second reinforced fiber bundle layer each formed of a plurality of reinforced fiber bundles aligned in one direction, arranged to have different fiber orientations from each other, and in which reinforced fiber bundles in one layer have no direct binding force between each other, the first reinforced fiber bundle layer and the second reinforced fiber bundle layer being fixed to each other by a fixing element so that the first reinforced fiber bundle layer and the second reinforced fiber bundle layer are integrated with each other, the reinforced fiber laminate sheet satisfying conditions (i) and (iii):
(i) the reinforced fiber laminate sheet has one or more fixing portions each including at least one fixing element at a fixing surface between the first reinforced fiber bundle layer and the second reinforced fiber bundle layer, and the fixing portions have an average area S₁ of 100 mm² or less; and
(iii) the fixing element is a particulate or fiber assembly-shaped fixing material that is melted.

20. The reinforced fiber laminate sheet according to claim 18, having a fixing region including at least one of the fixing portions at the fixing surface between the first reinforced fiber bundle layer and the second reinforced fiber bundle layer, wherein an area rate of the fixing region to the reinforced fiber laminate sheet is 30% or more and 100% or less.

21. The reinforced fiber laminate sheet according to claim 18, having at least one fixing region in which an area rate of one or more fixing portions to the fixing region is 1% or more and 50% or less.

22. The reinforced fiber laminate sheet according to claim 18, further satisfying condition (iv):
(iv) the reinforced fiber laminate sheet has a fixing region in which centers of the fixing portions are arranged in a polygonal grid.

23. The reinforced fiber laminate sheet according to claim 18, further satisfying condition (v):
(v) centers of the fixing portions are arranged in a regular polygonal grid having a side length L₁ (mm), and the length L₁ (mm) satisfies expression (1):
1≤L₁≤50 (1).

24. A fiber-reinforced resin molded body comprising: the reinforced fiber laminate sheet according to claim 18; and a matrix resin.

25. A method of manufacturing a reinforced fiber laminate sheet, the method comprising steps (a) to (c):
(a) a first reinforced fiber bundle layer arrangement step of arranging a plurality of reinforced fiber bundles aligned in one direction on a table to produce a first reinforced fiber bundle layer in which reinforced fiber bundles in one layer have no direct binding force between each other;
(b) a second reinforced fiber bundle layer arrangement step of further arranging, on the first reinforced fiber bundle layer, a plurality of reinforced fiber bundles aligned in one direction different from a fiber direction of the first reinforced fiber bundle layer to produce a second reinforced fiber bundle layer in which reinforced fiber bundles in one layer have no direct binding force between each other, and thus producing a reinforced fiber laminate; and
(c) a sheet forming step of obtaining a reinforced fiber laminate sheet satisfying conditions (i) and (ii) using a sheet forming mechanism of partially heating and/or pressurizing the reinforced fiber laminate via a protrusion on a surface in contact with the reinforced fiber laminate to melt a fixing material between the first reinforced fiber bundle layer and the second reinforced fiber bundle layer:
(i) the reinforced fiber laminate sheet has one or more fixing portions each including at least one fixing element at a fixing surface between the first reinforced fiber bundle layer and the second reinforced fiber bundle layer, and the fixing portions have an average area S₁ of 100 mm² or less; and
(ii) in each of the fixing portions, an area rate of the fixing element to the fixing portion is 0.1% or more and 80% or less.

26. A method of manufacturing a reinforced fiber laminate sheet, the method comprising steps (a) to (c):
(a) a first reinforced fiber bundle layer arrangement step of arranging a plurality of reinforced fiber bundles aligned in one direction on a table to produce a first reinforced fiber bundle layer in which reinforced fiber bundles in one layer have no direct binding force between each other;
(b) a second reinforced fiber bundle layer arrangement step of further arranging, on the first reinforced fiber bundle layer, a plurality of reinforced fiber bundles aligned in one direction that is different from a fiber direction of the first reinforced fiber bundle layer to produce a second reinforced fiber bundle layer in which reinforced fiber bundles in one layer have no direct binding force between each other, and thus producing a reinforced fiber laminate; and
(c) a sheet forming step of obtaining a reinforced fiber laminate sheet satisfying conditions (i) and (iii) using a sheet forming mechanism of partially heating and/or pressurizing the reinforced fiber laminate via a protrusion on a surface in contact with the reinforced fiber laminate to melt a fixing material between the first reinforced fiber bundle layer and the second reinforced fiber bundle layer:
(i) the reinforced fiber laminate sheet has one or more fixing portions each including at least one fixing element at a fixing surface between the first reinforced fiber bundle layer and the second reinforced fiber bundle layer, and the fixing portions have an average area S₁ of 100 mm² or less; and
(iii) the fixing element is a particulate or fiber assembly-shaped fixing material that is melted.

27. The method according to claim 25, comprising step (a1) between steps (a) and (b):
(a1) a fixing material placement step of placing a fixing material on the first reinforced fiber bundle layer.

28. The method according to claim 25, wherein the reinforced fiber bundles in step (a) and/or step (b) are reinforced fiber bundles to which a fixing material is attached.

29. The method according to claim 25, wherein the reinforced fiber laminate sheet has a fixing region including at least one of the fixing portions at the fixing surface between the first reinforced fiber bundle layer and the second reinforced fiber bundle layer, and an area rate of the fixing region to the reinforced fiber laminate sheet is 30% or more and 100% or less.

30. The method according to claim 29, wherein the reinforced fiber laminate sheet has at least one fixing region in which an area rate of one or more fixing portions to the fixing region is 1% or more and 50% or less.

31. The method according to claim 25, further satisfying condition (iv):
(iv) the reinforced fiber laminate sheet has a fixing region in which centers of the fixing portions are arranged in a polygonal grid.

32. The method according to claim 25, further satisfying condition (v):
(v) centers of the fixing portions are arranged in a regular polygonal grid having a side length L₁ (mm), and the length L₁ (mm) satisfies expression (1):
1≤L₁≤50 (1).

33. The method according to claim 25, comprising step (d) simultaneously with or after step (c):
(d) a fixing frame forming step of forming a fixing frame in at least a part of an end of the reinforced fiber laminate sheet.

34. The method according to claim 25, wherein the table has means that adsorb and hold the reinforced fiber bundles, and the means has a mechanism based on electrostatic attraction and/or a mechanism based on attractive force generated by flow of air.
